(19) United States
(12) Patent Application Publication
(10) Pub. No.: US 2010/0123089 A1
(43) Pub. Date: May 20, 2010

(54) Device for exciting fluorescent samples using visible light

(76) Inventor: Han-Min Chen, Taipei City (TW)

Correspondence Address: Han-Min, Chen ; Li-Ming, Chen, P.O. BOX 46-563 Taipei, Taipei, 10499, TW

(21) Appl. No.: 12/291,768

(22) Filed: Nov. 14, 2008

(51) Int. Cl. G01N 21/00

(52) U.S. Cl. 250/474.1

(57) ABSTRACT

This invention proposes a device for exciting fluorescent samples using visible light; the device comprising:
a transparent plate for guiding light;
at least one lighting source placed alongside the transparent plate;
such that the fluorescent samples placed on the transparent plate of the device is excited by the light refracted and reflected from the transparent plate according to Snell's law;
thus, the exciting S/N ratio can be improved by the light refraction of the device.

### BACKGROUND OF THE INVENTION

1. Field of the Invention

The invention relates to a device for exciting fluorescent samples using visible light. More particularly, the invention relates to a device for exciting fluorescently stained biological samples using visible light under Snell's law for improving exciting S/N ratio.

2. Description of the Related Art

Proteomics may be one of the most fascinating-omics in current life science research. With the remarkable advances in separation and identification techniques, in a high throughput way, proteomics allows for the identification of differentially expressed or modified proteins between experimental and control groups, or pathological and healthy samples. Since proteins are the terminally expressed molecules of signaling cascades, they more directly reflect the physiological responses of the cell than their nucleotide precursors. Thus, they are of great interest for life science research and medical diagnosis. Some proteins known as rare-message targets (e.g., interferons, lymphokines, and hormone receptors), however, are low in abundance and difficult to detect. This poses a major problem in modern molecular biology since amplification techniques, such as polymerase chain reaction (PCR) for nucleotides, does not exist for protein amplification. Some of these rare-message proteins are of great interest in modern medicine and therefore, high-sensitivity detection methods would be useful for their identification.

Polyacrylamide gel electrophoresis is probably one of the most widely utilized proteomic techniques. Recently, two-dimensional electrophoresis (2-DE), which simultaneously separates complex proteomes according to the isoelectric point and molecular weight of individual proteins, has become another popular approach in proteomics. To identify differentially expressed proteins by techniques such as mass spectrometry, proper protein gel staining methods must be used to reveal protein bands or spots in polyacrylamide gels. However, in many cases, the convenient dye-binding Coomassie Brilliant Blue is insufficient for revealing minor protein bands or spots. High-sensitivity staining methods such as silver stain or imidazole-zinc reverse stain may reveal protein bands or spots as low as 1 ng, but deliver a poorer dynamic range of staining and have issues arising from mass spectral compatibility. Recently, fluorescent protein gel stains such as SYPRO Ruby, Deep Purple, Flamingo and Krypton stains have been widely applied in proteomic experiments, as they deliver excellent sensitivity and a broader dynamic range than calorimetric methods. Other fluorescent protein gel stains, such as Pro-Q Diamond and Pro-Q Emerald, have been developed and utilized for revealing phosphoproteomes.

To illuminate fluorescent signals in a protein gel, fluorophores bound to the protein molecules have to be excited by light of a proper wavelength. For example, the high-energy blue laser (488 nm) in the Typhoon Trio laser gel scanner (GE Healthcare) is an effective light source to excite the bathophenanthroline complex of ruthenium (II), a fluorophore that encompasses a bimodal excitation profile (ex=280 and 450 nm, em=610 nm), in the SYPRO Ruby-stained gel. Recently, CCD camera gel documentation systems equipped with light-emitting diodes (LEDs), for example, the MF-ChemiBIS from DNR (Jerusalem, Israel), the LIAS ChemX from Avegene (Taipei, Taiwan) or the LAS-4000 from Fujifilm (Stamford, Conn.), have been utilized as an economic substitute to the expensive laser gel scanner. During the image documentation procedure, to obtain a high quality gel image with low background, noise resulting from the transmission or reflection of excitation light has to be properly filtered. For example, an amber filter (610 nm long pass or broad band-pass) is usually used to screen the blue laser or light when scanning or photographing SYPRO Ruby-stained gels.

In some circumstances, for example, when manually picking bands or spots from fluorescently stained protein gels, the direct visualization of the fluorescent signal is required. However, most gel image documentation instruments, such as laser gel scanners, are designed as closed systems and are not suitable for hands-on procedures. Ultraviolet (UV) transilluminators may be a feasible apparatus to fulfill the above requirement because both long wavelength (UVA) and short wavelength UV (UVB) can excite certain fluorophores. Now, many laboratories utilize UVB transilluminators for direct visualization of fluorescent signals in SYPRO Ruby-stained protein gels. However, the UV transilluminator setup has at least three shortcomings. First, direct and prolonged exposure in a UV radiation area is potentially hazardous to the operator, even when the appropriate safety equipment is utilized. Second, not every fluorophore can be sufficiently excited by the UV light. Fluorophores in some stains, such as Flamingo and Krypton, have low excitation maxima around 270 and 320 nm, making manual band or spot picking with UV transilluminators extremely difficult or impossible. Third, most fluorophores are susceptible to UV light induced photobleaching. For example, the half-life of the Deep Purple fluorescence was estimated to be only 6 minutes upon irradiation with UV light. In general, weak fluorescent signals in gels may become fainter or even invisible after prolonged exposure to UV light.

Lately, blue light transilluminators have been reported as ideal substitutes to UV transilluminators for direct visualization of fluorescent signals in protein gels. At least three products, such as the Dark Reader from Clare Chemical Research (Dolores, Colo.), the Safe Imager from Invitrogen (Carlsbad, Calif.), and the Visi-Blue transilluminator from UVP (Upland, Calif.), are commercially available. All of these utilize the broad bandwidth blue light to excite fluorophores and employ an orange or amber filter to screen the scattered blue light. These apparatuses have been utilized to excite fluorophores in stains such as SYPRO Orange, SYPRO Ruby and SYBR Green. Besides permitting the direct visualization of fluorescently stained protein gels, this setup may also be configured as a hand lamp or an integrated transilluminator-electrophoresis unit. The Clare Chemical Research company has even designed amber filter glasses to facilitate the operation of blue light transilluminators.

In comparison with visualization results obtained from UV transilluminators, blue light transilluminators generally deliver a fainter fluorescent signal. Presumably, the broad bandwidth blue light makes it a less effective excitation light source than UV light. Also, the thick orange or amber filter (0.5-1.0 cm) generally used for screening the emitted blue light also absorbs some of the fluorescent signal. Thus, applicability of blue light transilluminators is limited as it is sometimes difficult to directly visualize weak fluorescent signals in protein gels with these apparatuses.

### SUMMARY OF THE INVENTION

In the present invention, the inventors propose a device that utilizes a backlit blue light plate to illuminate fluorescent signals in polyacrylamide protein gels or the like for improving exciting S/N ration. The embodiment shows that this device is ideal for observation of various types of fluorescently stained protein gels and allows for the detection of some weak fluorescent signals with the naked eye and can be without the use of a filter. Wherein the device for direct visualization of fluorescent signals in protein gels using a backlit blue light plate comprises:
a transparent plate for guiding light;
at least one lighting source placed alongside the transparent plate;
such that the fluorescent samples placed on the transparent plate of the device is excited by the light refracted and reflected from the transparent plate according to Snell's law; thus the exciting S/N ration can be improved by the light refraction of the device.

### BRIEF DESCRIPTION OF THE DRAWINGS

FIG. 1 is setup of the device of the present invention (FIG. 1a) and comparison of its usefulness for visualizing fluorescently stained protein gels with other setups (FIG. 1b to 1h).

FIG. 2 is diagrams of all possible light paths in the backlit blue light plate setup.

FIG. 3 is quantitative comparison of SYPRO Ruby-stained gel images photographed on the backlit blue light plate or documented by the laser gel scanner.

FIG. 4 is the application of backlit light plate for visualizing the SYBR Safe stained DNA gel.

### DETAILED DESCRIPTION OF THE PREFERRED EMBODIMENT

### Materials and Methods—Preparation

A commercial standard protein mixture (GE Healthcare, Piscataway, N.J.) containing rabbit muscle glycogen phosphorylase b (GP), bovine serum albumin (BSA), chicken egg ovalbumin (OVA), bovine erythrocyte carbonic anhydrase (CA), soybean trypsin inhibitor (TI) and bovine lactalbumin (LAC) was two-fold serially diluted from 4,000 to 7.8 ng of total protein and separated by 15% SDS-PAGE. All electrophoretic procedures were performed according to standard protocol with minor modifications. The electrophoretic protein gels were treated by either SYPRO Ruby, SYPRO Tangerine, SYPRO Orange (Invitrogen, Grand Island, N.Y.), or Deep Purple (GE Healthcare, Piscataway, N.J.) according to the manufacturers' instructions.

### Gel Image Documentation and Analysis

A backlit blue light plate installed with two blue linear cold cathode fluorescent lamps (CCFLs) of 5 Watts (2000 lux, 30 cm), was purchased from Taiwan local electronic vendors. The blue light transilluminator, Dark Reader DR-88, was purchased from Clare Chemical Research (Dolores, Colo.). For direct observation of fluorescently stained protein gels, an amber acrylic plate (1.0 cm thick) was used as a filter for removal of transmitted or refracted blue light. A digital camera (Canon A700) equipped with the same amber acrylic filter (2.0 mm thick) was used to capture images of the gels. Identical photographing parameters were employed—exposure time off 4 seconds and an aperture of 8. A UV transilluminator (TD-2000E, 365 nm/312 nm, Spectronics, Westbury, N.Y.) was also evaluated in parallel.

Additionally, SYPRO Ruby- or Deep Purple-stained gels were documented by a laser gel scanner (Typhoon Trio, GE Healthcare, Piscataway, N.J.), using a 488 or 532 nm excitation laser and the 610(30) nm band-pass filter.

### Assembly of the Backlit Blue Light Plate of Present Invention

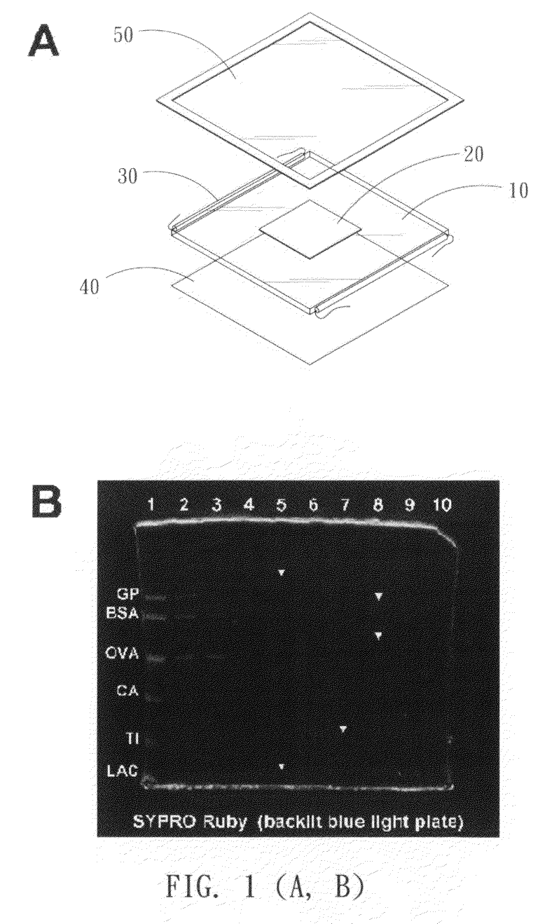

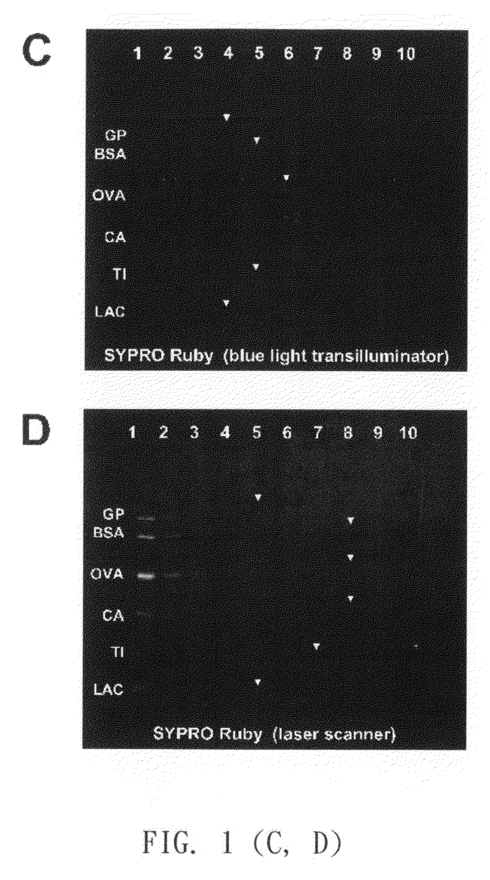

1. Assembly of the backlit blue light plate of the present invention is illustrated in FIG. 1A. The assembly form bottom to top is formed by a black background 40, glass made transparent plate 10, gel 20 and two blue linear CCFLs 30 were placed alongside the glass made transparent plate 10 as a light source. The black background 40 was laid underneath the glass plate 10 for better contrast and a plastic cover 50 was positioned above the glass plate 10 to block unwanted refracted light. A backlit blue light plate such as this one may be purchased from electronic vendors for less than 70 USD. The blue linear CCFLs 30 can be another visible light source with different color (I.e. white), the present invention uses blue light to illustrate, but not intend to be limited thereto. Furthermore, the transparent plate 10 can be a thin glass or a plastic plate and the thickness of the transparent plate 10 is less than 1 cm. The light source can be linear Cold cathode fluorescent lamps or LED. And, light source can be visible or invisible light.

### Visual Evaluation of Fluorescently Stained Protein Gels Using Different Illumination Setups

First, the present invention compared results for fluorescently stained protein gels illuminated by the backlit blue light plate and the blue light transilluminator. The most commonly used fluorescent protein gel stain, SYPRO Ruby (λex/λem=280 and 450 nm/610 nm), was chosen for assessment. It was found that the backlit blue light plate delivered extraordinary images of SYPRO Ruby-stained protein gels, with intense fluorescent signals and low backgrounds. Bands containing as little as 5 ng of protein could be directly visualized by looking through an amber filter or filter glasses (FIG. 1B, red triangle 1 indicates the 4.5 ng carbonic anhydrase). In contrast, fewer and fainter fluorescent signals could be seen from the same gel with the blue light transilluminator (FIG. 1C). For example, the visible ruby band containing the least amount of protein in FIG. 1C is 18 ng of carbonic anhydrase (indicated by red triangle 2). After numerous trials, it was found that the protein signal detected in a SYPRO Ruby-stained gel was at least four-fold stronger using the backlit blue light plate in comparison to the blue light transilluminator.

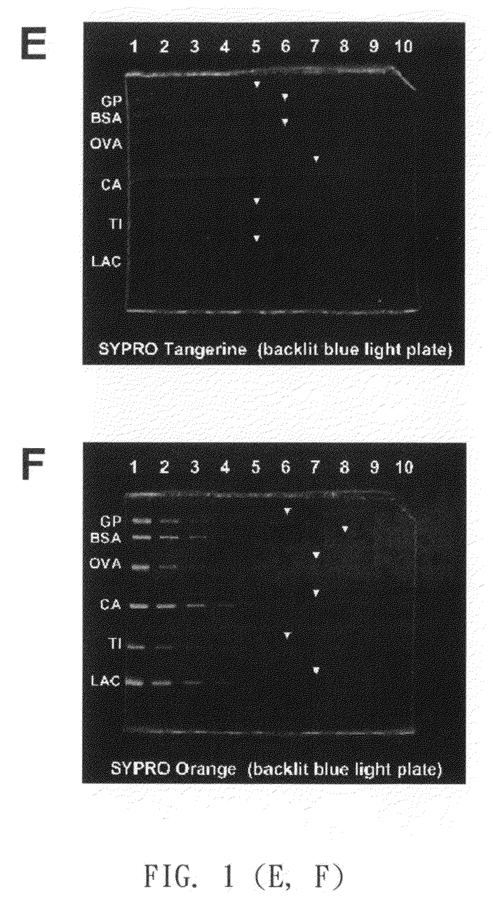

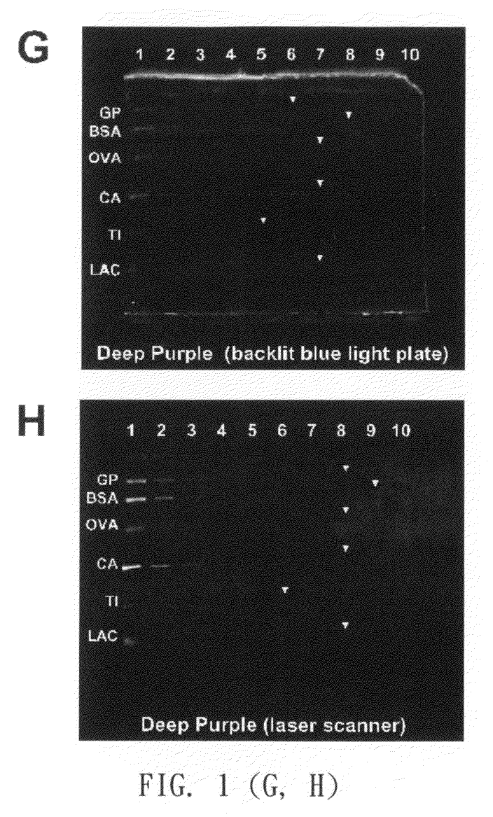

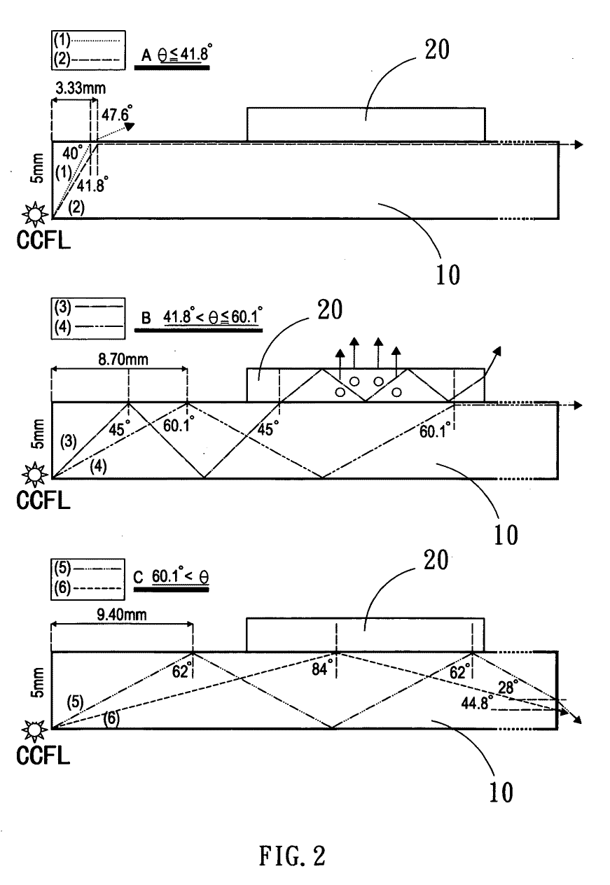

Nearly all SYPRO Ruby fluorescent signals in gels documented by a laser gel scanner (FIG. 1D) could be directly seen by the eye with the aid of a backlit blue light plate, indicating that this setup allows for manual recovery of less abundant proteins from SYPRO Ruby-stained protein gels. Prolonged exposure to the visible blue light is not only safe to operators but also to fluorophores, as the present invention did not observe apparent photobleaching of the SYPRO Ruby-stained protein gel even after it was left on the backlit blue light plate for an hour (data not shown). It was noticed that in the backlit blue light plate setup, a visible blue light always glowed on the edge of the protein gel, but this was not the case in the blue light transilluminator setup. Nevertheless, this blue light, which was a result of the total internal reflection of blue light in the illuminated protein gel (see FIG. 2b), did not significantly interfere with observation of the protein bands. It should also be mentioned that even without the use of a filter or filter glasses, all SYPRO Ruby fluorescent signals were still discernible on the backlit blue light plate setup. Such direct observation using the blue light transilluminator or UV transilluminator was not possible. For this reason, this fascinating feature may permit researchers not only a comfortable but also a safe procedure for manually picking bands or spots from certain fluorescently stained protein gels.

Visualization of Other Fluorescent Signals in Protein Gels by Using the Backlit Blue Light Plate

The backlit blue light plate setup is versatile for proteomic experiments because signals from many types of fluorescent stains may be clearly seen. For example, results from electrophoretic gels treated by SYPRO Tangerine (λex/λem=300 and 490 nm/640 nm) and SYPRO Orange (λex/λem=300 and 470 nm/570 nm) were both detected well by using the backlit blue light plate (FIGS. 1E and 1F). Additionally, this setup also allowed for clear visualization of fluorophores with a lower excitation coefficient, such as the one in Deep Purple (λex/λem=532 nm/610 nm, ε=20,000) (shown black-white in FIG. 1G). Nearly all Deep Purple fluorescent signals in gels documented by a laser gel scanner (shown black-white in FIG. 1H) could be directly seen by the eye with the aid of a backlit blue light plate. The other two commonly used fluorescent protein gel stains, Krypton (λex/λem=518 nm/552 nm) and Flamingo (λex/λem=515 nm/545 nm), were not selected for evaluation because the utilized amber filter may theoretically screen the emitting signals around 550 nm. Besides, the utilized broad bandwidth blue light from CCFLs may provide insufficient excitation energy but introduce significant background noise.

Briefly, for the well utilized SYPRO Ruby and Deep Purple, the backlit blue light plate setup delivered clearer visualization of those fluorescently stained protein gels (FIGS. 1B and 1G) than the commonly used UVA or UVB transilluminator method. On the other hand, employing the blue light transilluminator delivered overall dimmer visualization of those fluorescently stained protein gels (FIG. 1C). The thick orange or amber filter used for screening the emitted blue light, presumably, also absorbs significant amount of the fluorescent signals. Thereafter, on the blue light transilluminator those weak fluorescent signals in protein gels were difficult to detect.

Application of Backlit Light Plate for Visualizing the SYBR Safe Stained DNA Gel

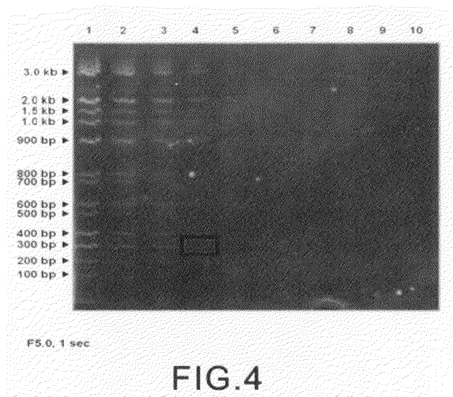

Method: DNA ladder markers ranging from 50 bps to 3 Kbps with two fold serial dilutions were firstly separated by 7.5% poly-acrylamide gel then developed by SYBR® safe DNA staining kit (Invitrogen). The maximal amount of each ladder markers was listed at left side of FIG. 4. The SYBR® safe stained DNA gel was then photographed with the blue backlit light plate illumination.

### Light Paths in a Backlit Blue Light Plate of Present Invention

The backlit blue light plate method was based on Snell's law. This has been used previously in TIRFM (total internal reflection fluorescent microscopy) to deliver an excellent fluorescent signal to background noise ratio for visualizing objects on slides. Next, the present invention discusses the paths of light from the blue CCFLs 30 to the glass plate 10 to explain the visualization achieved.

The critical angles (θ_{c}) involved in the backlit blue light plate applications are shown as follows.
θ_{c(glass:air)}: the critical angle between the glass and the air
θ_{c(glass:acrylamide)}: the critical angle between the glass and the polyacrylamide gel
θ_{c(acrylamide:air)}: the critical angle between the polyacrylamide gel and the air

incident angle θ=<θ_{c(glass:air)} (1)

Because glass has a larger refractive index (n_{glass}=1.5) than air (nₐᵢᵣ=1.0), only light emitted from the glass plate 10 with an incident angle θ smaller than the critical angle θ_{c(glass:air)} 41.8°(=sin⁻¹(nₐᵢᵣ/n_{glass})=sin⁻¹ 1/1.5) will be refracted into the air with the refractive angle θ_{1′}. For instance, blue light with an incident angle θ₁ of 40° was refracted into the air with a new refractive angle of 74.6° (sin 40°×1.5=sin 74.6°×1.0) (FIG. 2A, path 1). Since the blue CCFL 30 was located alongside a very thin (less than 5 mm) glass plate 10 in the backlit blue light setup, no refracted blue light could go farther than 3.33 mm from the edge of the glass plate 10 (5 mm×Tan 41.8°). Furthermore, it was blocked by a plastic cover 50 (FIG. 1A). Blue light with an incident angle θ₂ equal to the critical angle θ_{c(glass:air)} 41.8° was totally refracted and traveled parallel with the glass plate 10 (FIG. 2A, path 2). In the glass plate 10, all blue light emitted by the blue CCFL 30 with an incident angle larger than the critical angle θ_{c(glass:air)} 41.8° was reflected back and traveled within the glass plate 10 as seen in the application of optical fibers. Therefore, even when the blue CCFL 30 was turned on, most of the glass plate 10 (farther than 3 mm from the edge of the glass plate 10) appeared dimmer if a black background 40 was placed underneath the glass plate 10 (FIG. 1A). Thus, in theory, when observing any object above a backlit blue light plate, no light should be parallel to the angle of observation.

θ_{c(glass:air)}<incident angle θ=<θ_{c(glass:acrylamide)} (2)

As the major constituents of a polyacrylamide gel are water and acrylamide, the refractive index of a given polyacrylamide gel may depend on concentration of the gel. To inventor's knowledge, no refractive index has been measured for crystalline acrylamide powder. However, a similar substance, poly (methyl 2-methylpropenoate), also known as acrylic, has a refractive index of 1.49. As the refractive index of water is 1.33, it is reasonable to assume that the refractive index of most polyacrylamide gels is between 1.33 and 1.49. The refractive index of a polyacrylamide gel of an unspecified concentration has been measured as 1.47. Nevertheless, polyacrylamide gels should always have refractive indices n_{acrylamide} larger than nₐᵢᵣ, but smaller than n_{glass}. If a polyacrylamide gel with a refractive index of 1.4 is placed on the glass plate, light of blue CCFL 30 with an incident angle θ smaller than the critical angle θ_{c(glass:acrylamide)} 60.1°(=sin⁻¹(n_{acrylamide}/n_{glass})=sin⁻¹ 1.4/1.5) will be refracted into the gel. Therefore, in the backlit blue light plate setup, only light emitted by the blue CCFL 30 with an incident angle θ between 41.8° and 60.1° was refracted into the polyacrylamide gel with a corresponding refractive angle of θ. For instance, between the interface of the glass plate 10 and the gel 20, blue light with an incident angle θ₃ of 45° was refracted into the gel at a new refractive angle θ_{3′} of 49.3° (sin 45°×1.5=sin 49.3°×1.4) (FIG. 2B, path 3 in blue). Since the new incident angle θ_{3*}, which is equal to its alternate interior angle θ_{3′}, was larger than the critical angle θ_{c(acrylamide:air)} (45.9°=sin⁻¹(nₐᵢᵣ/n_{acrylamide})), when a fluorescently stained protein gel was placed on the backlit blue light plate, the refracted blue light in the gel that did not excite fluorophores never traveled into the air. Instead, it was totally reflected back and traveled within the gel until it reached the vertical side of the gel. At this interface, the blue light noted above may have had another incident angle θ_{3″}40.7° (90°−49.3°=40.7°), which was smaller than the critical angle θ_{c(acrylamide:air)} 45.9°. Therefore, it eventually refracted into the air with a new refractive angle of 65.9° (sin 40.7°×1.4=sin 65.9°×1.0). This may explain the blue light glow on the edge of the polyacrylamide gel (FIG. 1B). Blue light with an incident angle θ₄ equal to the critical angle θ_{c(glass:acrylamide)} 60.1° was refracted and traveled parallel with the glass plate (FIG. 2B, path 4).

Taken together, it appears that the light emitted from the blue CCFLs 30 with a primary incident angle θ₃ larger than the critical angle θ_{c(glass:air)} but smaller than the critical angle θ_{c(glass:acrylamide)} will be refracted from the glass plate 10 into the polyacrylamide gel 20, totally reflected by air, and eventually emitted from the edge of the gel 20. Presumably, none of the above light is emitted on the surface of the gel 20.

θ_{c(glass:acrylamide)}<incident angle θ (3)

At interface of the glass plate 10 and polyacrylamide gel, light emitted by the blue CCFLs 30 with an incident angle θ larger than the critical angle θ_{c(glass:acrylamide)} 60.1° should be totally reflected by the gel back into the glass plate 10 and eventually emitted at the edge of the glass plate. For instance, blue light with an incident angle θ₅ of 62° was totally reflected back to the gel and eventually emitted at the edge of the glass plate 10 at another incident angle θ_{5′} of 28° (90°−62°) and a refraction angle θ_{5″} of 44.8° (sin 28°×1.5=sin 44.8°×1.0) (FIG. 2C, path 5). Some nearly parallel blue light should also have been emitted directly by blue CCFLs 30 to the polyacrylamide gel with a much larger incident angle θ. This blue light was supposed to be totally reflected by the gel back into the glass plate 10 and eventually emitted at the edge of the glass plate 10. For instance, blue light with an incident angle θ₆ of 84° was eventually emitted at the edge of the glass plate 10 with an incidence angle θ_{6′} of 6° (90°−84°) and a refraction angle θ_{6″} of 9° (sin 6°×1.5=sin 9°×1.0) (FIG. 2C, path 6).

### Image Quality Evaluation of Fluorescently Stained Protein Gels Photographed on the Backlit Blue Light Plate

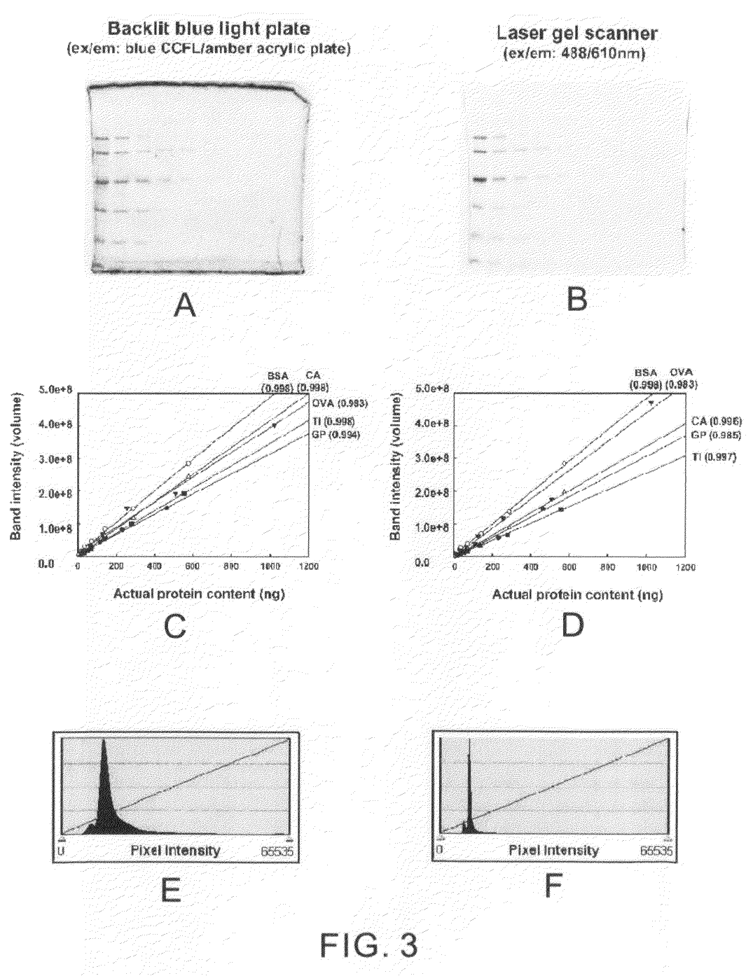

The present invention examined whether photographed images of the gels on the backlit blue light plate were suitable for quantitative analysis. To assess this, SYPRO Ruby-stained gel images were photographed on the backlit blue light plate (FIG. 1B) or documented by the laser gel scanner (FIG. 1D) were first converted to 16-bit grayscale positive images (FIG. 3A and FIG. 3B), and subsequently evaluated using 1-D gel image analysis software. Both gel images delivered comparable results, allowing for a good dynamic range of staining for proteins. There was excellent linearity between the band intensity and the actual protein content, ranging from ng to μg (FIG. 3C and FIG. 3D). Additionally, a similar grayscale distribution (grayscale histogram profiles) was observed in both images (FIG. 3E and FIG. 3F). Based on this information, it is likely that the backlit blue light plate method is an effective apparatus for direct observation of the fluorescent signals in protein gels and also an economic and reliable excitation light source for photographing the analyzable gel images.

### Conclusion

In the backlit blue light plate setup, only blue light emitted by CCFLs with a primary incident angle larger than the critical angle θ_{c(glass:air)} but smaller than the critical angle θ_{c(glass:acrylamide)} was refracted from the glass plate 10 into the polyacrylamide gel, totally reflected within the gel, and eventually emitted at the edge of the gel (FIG. 2, path 3). Other blue light was refracted either directly into the air (FIG. 2, path 1) or eventually emitted at the side of the glass plate (FIG. 2, paths 2, 4, 5, and 6). No blue light emitted by blue CCFLs 30 went directly into the eyes of observers. This most likely explains why fluorescent signals were seen on the backlit blue light plate without filters or filter glasses. Also, this invention allowed for better quality gel images (intense signal/low background noise ratio) to be obtained than with the blue light transilluminator (FIG. 1B and FIG. 1C). Our results indicated that this safe, economic and convenient setup was also an effective means for illuminating fluorescently stained protein gels.

It has to be noted that the refractive index of light is wavelength dependent. For light with different wavelength (λ), the corresponding refractive index (n) in a specific material can be deduced using Sellmeier equation as follows.

n²(λ)=1+B₁λ²/(λ²−C₁)+B₂λ²/(λ²−C₂)+B₃λ²/(λ²−C₃)

where B₁, B₂, B₃ and C₁, C₂, C₃ are experimentally determined Sellmeier coefficients. For examples, the refractive index of glass (SiO₂) for 350 nm, 450 nm, 550 nm and 650 nm light is 1.56560, 1.55257, 1.54599 and 1.54210 respectively, while the refractive index of air for light with the corresponding wavelengths is 1.000284, 1.000279, 1.000277 and 1.000276 respectively. Accordingly, the refractive index for light with longer wavelengths is lower than those for shorter wavelengths. However, the above wavelength issue does not significantly alter the critical angle of light. For examples, at the interface between glass and air the critical angle for 350 nm, 450 nm, 550 nm and 650 nm light is calculated as 39.7°, 40.1°, 40.3° and 40.4° respectively. Thereafter, the application of backlit light plate setup will not be limited when the input light with different wavelengths is used.

Conclusion: With the aid of the blue backlit light plate illumination, visualization of the SYBR® stained DNA gel is also possible, as that seen for fluorescently stained protein gels. In this setup, as low as 2 ng of DNA can be visualized by the eyes (FIG. 4, red rectangle indicates the minimal DNA band observed). Thus, the blue backlit light plate method is not only safe and convenient, in comparison to UV transilluminators, but also versatile for illuminating the fluorescent signals in various kinds of biological samples.

What is claimed is:

1. A device for exciting fluorescent samples using visible light, the device comprising:
a transparent plate for guiding light;
at least one lighting source placed alongside the transparent plate;
such that the fluorescent samples placed on the transparent plate of the device is excited by the light refracted and reflected from the transparent plate according to Snell's law;
thus, the exciting S/N ratio can be improved by the light refraction of the device.

2. The device as claimed in claim 1, wherein the sample is any one of fluorescently stained or labeled DNA, proteins or any other biological samples which can be excited by guided light.

3. The device as claimed in claim 1, wherein a black background is laid underneath the transparent plate for better contrast.

4. The device as claimed in claim 1, wherein a filter can be placed above the samples to shield irregularly refracted light for enhancing the visualization.

5. The device as claimed in claim 1, wherein the transparent plate is a thin glass or plastic plate.

6. The device as claimed in claim 1, wherein the light source is linear cold cathode lamps (CCFLs) or light emitting diodes (LEDs).

7. The device as claimed in claim 1, wherein poly-acrylamide or agarose gel can be applied on the device.

8. The device as claimed in claim 7, wherein the sample can be stained by one of SYPRO Ruby, Deep Purple, Flamingo, Krypton stains and Pro-Q Diamond, Pro-Q Emerald and SYPRO Safe.

9. The device as claimed in claim 1, wherein the thickness of the transparent plate is less than 1 cm.

10. The device as claimed in claim 1, wherein the light source can be visible or invisible light.
